(19) United States
(12) Patent Application Publication
(10) Pub. No.: US 2017/0285641 A1
(43) Pub. Date: Oct. 5, 2017

(54) SYSTEMS AND PROCESSES FOR SELECTING CONTEXTUAL MODES FOR USE WITH AUTONOMOUS, SEMI-AUTONOMOUS, AND MANUAL-DRIVING VEHICLE OPERATIONS

(71) Applicant: GM Global Technology Operations LLC, Detroit, MI (US)

(72) Inventors: Claudia V. Goldman-Shenhar, MEVASSERET ZION (IL); Gila Kamhi, ZICHRON YAAKOV (IL); Nadav Baron, Herzliya Pituach (IL); Barak Hershkovitz, Herzliya Pituach (IL)

(21) Appl. No.: 15/477,497

(22) Filed: Apr. 3, 2017

Related U.S. Application Data
(60) Provisional application No. 62/317,006, filed on Apr. 1, 2016.

(51) Int. Cl. G05D 1/00; B60R 16/023; B60W 30/095; B60W 30/182; G05D 1/02

(52) U.S. Cl. CPC G05D 1/0088; B60W 30/182; G05D 1/0276; B60W 30/0956; B60R 16/0231; B60W 2550/20

(57) ABSTRACT

A system including an input group that, when executed by a processing unit, obtains contextual input data for use in determining a contextual mode, wherein the contextual input is based on at least one type of context. Example contexts include an environmental context; a user state; a user driving destination; a profile of the user; and a profile of another user. The system also includes a deliberation group that, when executed by the processing unit, determines, based on the contextual input data, a contextual mode for use in controlling a vehicle function. The system also includes an output group that, when executed by the hardware-based processing unit, initiates implementation, at a vehicle of transportation, of the contextual mode determined to control the vehicle function.

### TECHNICAL FIELD

The present disclosure relates generally to driving modes of vehicles such as automobiles and, more particularly, to systems and processes configured to adaptively select or establish driving modes for autonomous, semi-autonomous, and human-driven vehicles, based on factors. Example factors include (i) environmental context, (ii) driver state, (iii) driver activity during driving (regarding autonomous driving, for instance), (iv) driving destinations, and (v) profiles of other drivers. The vehicle is configured to, in response to establishment or selection of a contextual driving mode, adjust vehicle sub-systems, such as HVAC, infotainment, and vehicle-dynamics sub-systems (chassis, braking, powertrain, power steering, etc.), and user devices, such as a wearable device, accordingly.

### BACKGROUND

This section provides background information related to the present disclosure which is not necessarily prior art.

Conventional driving mode control (DMC) systems adjust one or more of vehicle (1) chassis dampers or shock absorbers, (2) powertrain, and (3) power steering based on user selection of one of two or three static modes—i.e., normal, touring, or sport.

Some modern DMC systems are configured to monitor a manner by which the vehicle is being driven—e.g., aggressively—and temporarily decisively change the mode accordingly. If the vehicle is in static normal mode but the vehicle is being driven around curves at relatively high speeds, for instance, the DMC system can change the vehicle to the static sport mode.

The static and limited nature of conventional systems does not meet all driver needs, such as by failing to accommodate numerous driving-related contexts and types of user preferences.

### SUMMARY

The technology in various embodiments includes a system having a hardware-based processing unit and a non-transitory computer-readable storage device. The storage device, or memory, includes an input group of one or more input modules, a deliberation group of one or more mode-selection or -generation modules, and an output group of one or more system output modules.

Example input group modules include a driving-destinations input module, a user-state input module, an environmental-context input module, other's-profiles input module, and a user-activity input module. The input group is configured to determine a contextual input to provide to a deliberation group of the system.

Example deliberation group modules include a contextual-mode selection module, or contextual agent, a contextual-modes database module, and a contextual-mode generation module. The group is configured to determine, based on the contextual input, a contextual mode, corresponding to numerous vehicle and non-vehicle settings.

Example output group modules include an extra-dynamics vehicle output module, a connected-devices output module, and a vehicle-dynamics output module. The output group is configured to initiate execution of the contextual mode including initiating various settings corresponding to the contextual mode determined.

In various implementations, system output includes at least one type of output selected from a group consisting of: non-vehicle output and non-dynamic vehicle output, such as being associated with an infotainment sub-system of the vehicle and/or a heating, ventilating, air-conditioning sub-system of the vehicle.

In various embodiments, the modules comprise code configured to cause the processing unit to perform operations including determining, based on a user-state, an appropriate contextual mode, and initiating setting of multiple vehicle and non-vehicle settings based on the contextual mode determined.

In various embodiments, the modules comprise code configured to cause the processing unit to perform operations including determining, based on a user-activity, an appropriate contextual mode, and initiating setting of multiple vehicle and non-vehicle settings based on the contextual mode determined.

In various embodiments, the modules comprise code configured to cause the processing unit to perform operations including determining, based on another-user profile, an appropriate contextual mode, and initiating setting of multiple vehicle and non-vehicle settings based on the contextual mode determined.

In various embodiments, the modules comprise code configured to cause the processing unit to perform operations including determining, based on an environmental context, an appropriate contextual mode, and initiating setting of multiple vehicle and non-vehicle settings based on the contextual mode determined.

In various embodiments, the modules comprise code configured to cause the processing unit to perform operations including determining, based on a user destination, an appropriate contextual mode, and initiating setting of multiple vehicle and non-vehicle settings based on the contextual mode determined.

The technology also includes processes, algorithms, and the computer-readable storage device corresponding to the systems described above. The technology can be implemented by, and in some cases included as part of, a vehicle of transportation, such as, but not limited to, an automobile.

Other aspects of the present technology will be in part apparent and in part pointed out hereinafter.

### DESCRIPTION OF THE DRAWINGS

FIG. 1 illustrates schematically an example vehicle of transportation according to embodiments of the present technology.

FIG. 2 illustrates schematically an example vehicle computer in communication with a remote/local mobile computing system.

FIG. 3 shows example memory components of the computer architecture of FIG. 2.

FIG. 4 shows an exemplary process flow, according to embodiments of the present technology.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Technology Introduction

The present disclosure relates systems, algorithms, and processes configured to adaptively select or establish driving modes for autonomous, semi-autonomous, and human-driven vehicles, based on factors such as any of (i) environmental context, (ii) driver state, (iii) driver activity during driving (for, e.g., autonomous driving), and (iv) pre-established profiles, such as those of other drivers or those based on user- or system-pre-set driving destinations.

The vehicle is configured to, in response to establishment or selection of a contextual driving mode, adjust, accordingly, various vehicle sub-systems and/or user devices—such as a wearable device or smart phone, other smart devices or adjustable and connected devices, connected to the car.

Contextual driving modes are associated with corresponding sets of values for settings of the various sub-systems and/or user devices.

While the present technology is described primarily with respect to automobiles, the technology is not limited by the focus. The concepts can be extended to a wide variety of applications, such as aircraft, marine craft, the like, and other.

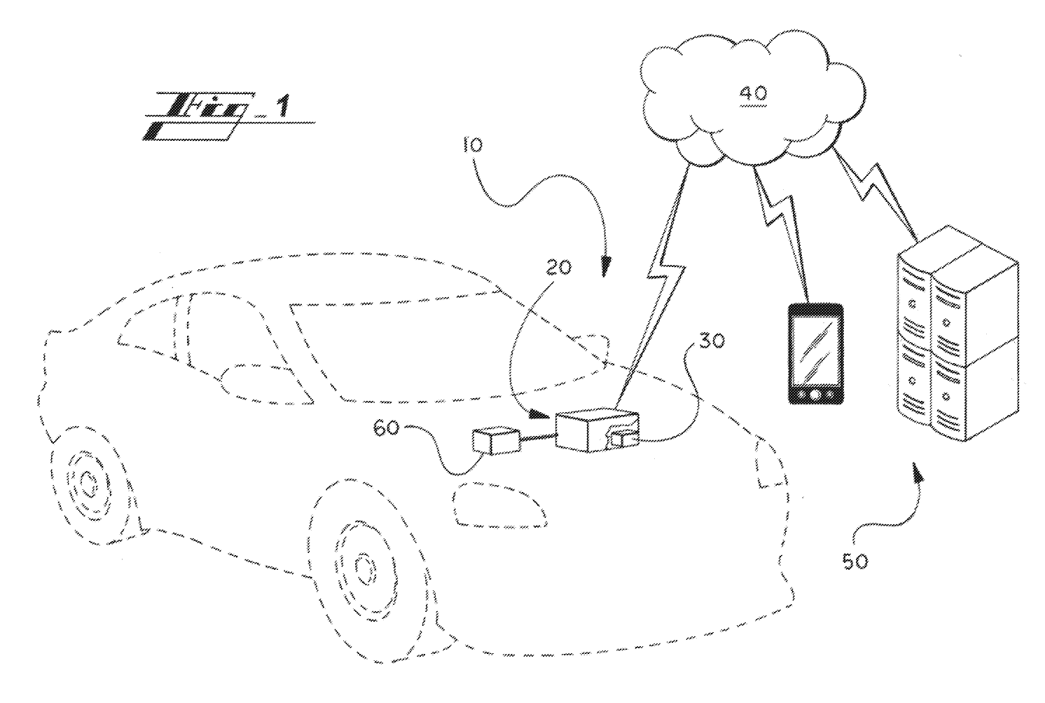

### II. Host Vehicle—FIG. 1

Turning now to the figures and more particularly the first figure, FIG. 1 shows an example host structure or apparatus 10 in the form of a vehicle, and particularly an automobile.

While the present technology is described primarily with respect to vehicles, and particularly automobiles, as the host apparatus 10, the technology is not limited by the focus. The concepts can be extended to a wide variety of applications, such as aircraft, marine craft, other transportation or moving vehicles (for example, forklift), the like, and other. As other examples, the concepts can be used in the trucking industry, bussing, construction machines, or agricultural machinery.

The vehicle 10 includes a hardware-based controller or controlling system 20. The hardware-based controlling system 20 includes a communication sub-system 30 for communicating with one or more local and/or external networks 40, such as the Internet, to reach local or remote systems 50, such as servers or mobile devices.

The vehicle 10 also includes a sensor sub-system 60 comprising sensors providing information to the hardware-based controlling system 20 regarding items such as, but not limited to, vehicle operations, vehicle position, vehicle pose, driver biometrics/physiology, and/or an environment about the vehicle 10, such as road conditions, traffic, other vehicle features such as other-vehicle dynamics (position, direction, speed, etc.), weather, etc.

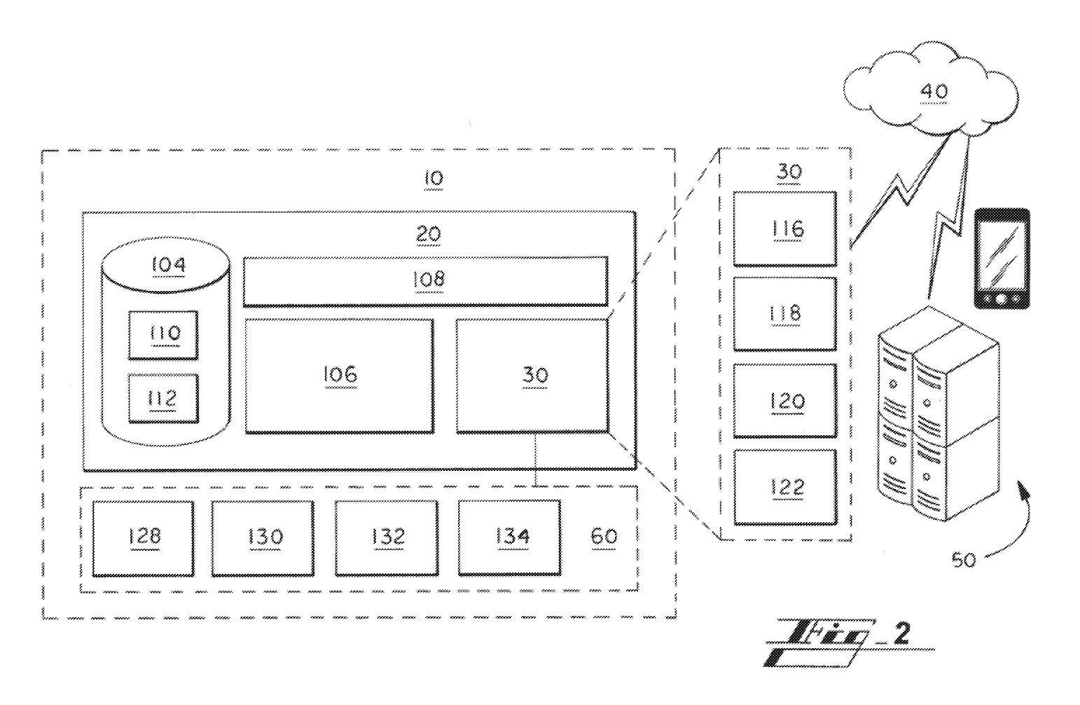

### III. On-Board Computing Architecture—FIG. 2

FIG. 2 illustrates in more detail the hardware-based computing or controlling system 20 of FIG. 1. The controlling system 20 can be referred to by other terms, such as computing apparatus, controller, controller apparatus, or such descriptive term. As mentioned, the controller system 20 is in various embodiments a part of a greater system 10, such as a vehicle.

The controlling system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), programmable gate array (PGA) including a Field PGA, or state machine. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

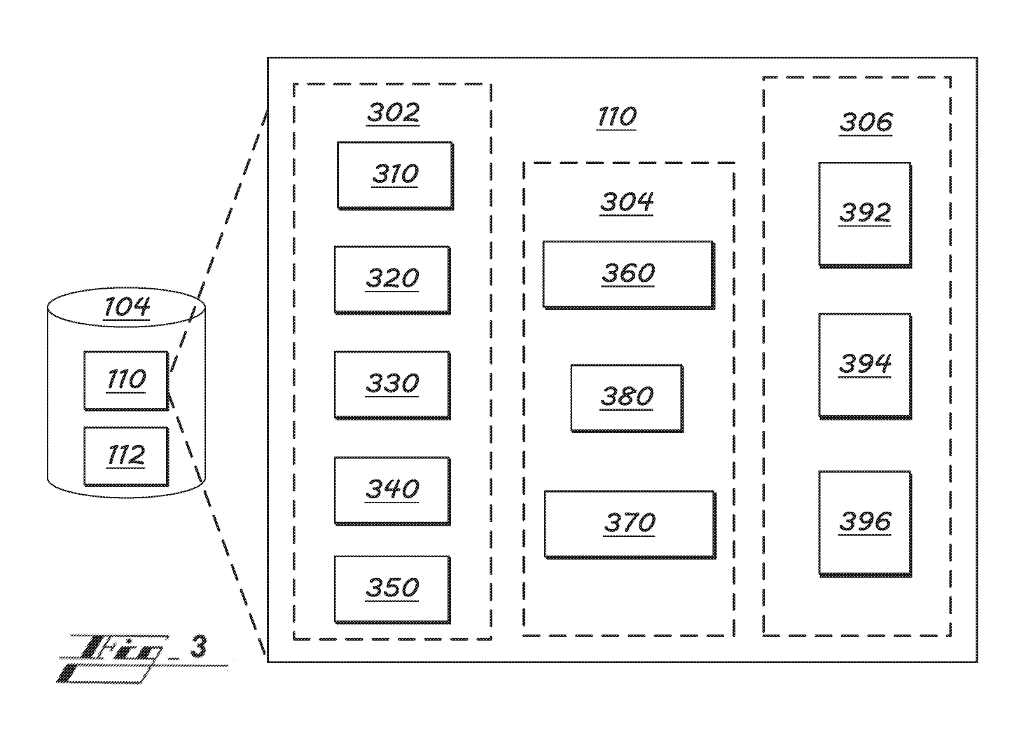

The data storage device 104 includes one or more storage modules 110 storing computer-readable code or instructions executable by the processing unit 106 to perform the functions of the controlling system 20 described herein. The modules and functions are described further below in connection with FIG. 3.

The data storage device 104 in some embodiments also includes ancillary or supporting components 112, such as additional software and/or data supporting performance of the processes of the present disclosure, such as one or more user profiles or a group of default and/or user-set preferences.

As provided, the controlling system 20 also includes a communication sub-system 30 for communicating with one or more local and/or external networks 40, such as the Internet, or local or remote systems 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controlling system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controlling system 20 can, by operation of the processor 106, send and receive information, such as in the form of messages or packetized data, to and from the one or more communication networks 40.

External devices 50 with which the sub-system 30 communicates are in various embodiments nearby the vehicle, remote to the vehicle, or both.

An example nearby or local system 50 can include a user device such as a smartphone, a wearable device, or other connected device, connected or connectable to the vehicle 10, by wire or wirelessly.

Example remote systems 50 include a remote server (for example, application server), or a remote data, customer-service, and/or control center. An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controlling system 20 regarding items such as vehicle operations, vehicle position, vehicle pose, user characteristics, such as biometrics or physiological measures, and/or the environment about the vehicle 10, such as road conditions, traffic, other vehicle features such as other-vehicle dynamics (position, direction, speed, etc.), weather, etc. The arrangement can be configured so that the controlling system 20 communicates with, or at least receives signals from sensors of the sensor sub-system 60, via wired or short-range wireless communication links 116, 120.

In various embodiments, the sensor sub-system 60 includes at least one camera 128 and at least one range sensor 130, such as radar or sonar. The camera 128 may include a monocular forward-looking camera, such as those used in lane-departure-warning (LDW) systems. Other embodiments may include other camera technologies, such as a stereo camera or a trifocal camera.

Sensors configured to sense external conditions may be arranged or oriented in any of a variety of directions without departing from the scope of the present disclosure. For example, the cameras 128 and the range sensor 130 may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 130 may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include an inertial-momentum unit (IMU) 132, such as one having one or more accelerometers, and other dynamic vehicle sensors 134, such as a wheel sensor or a sensor associated with a steering system (for example, steering wheel) of the vehicle 10.

The sensors can include any sensor for measuring a vehicle pose or other dynamics, such as position, speed, acceleration, or height—e.g., vehicle height sensor.

The sensors can include any known sensor for measuring an environment of the vehicle, including those mentioned above, and others such as a precipitation sensor for detecting whether and how much it is raining or snowing, a temperature sensor, and any other.

Sensors for sensing user characteristics include any biometric sensor, such as a retina or other eye scanner or sensor, camera, microphone associated with a voice recognition sub-system, a weight sensor, salinity sensor, breath-quality sensors (e.g., breathalyzer), a temperature sensor, or other.

User-vehicle interfaces, such as touch screen displays, buttons, knobs, the like, or other can also be considered part of the sensor sub-system 60.

### IV. Data Structures—FIG. 3

FIG. 3 shows in more detail example structure of the data storage device 104 of FIG. 2.

As mentioned, the data storage device 104 includes one or more modules 110. And The data storage device 104 may also include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

The modules are shown grouped into three primary groups or modules: an input group 302, a deliberation, or contextual mode-selection, group 304, and an output group 306, as shown in FIG. 3.

The modules 110 in various embodiments include at least eleven (11) modules 310, 320, 330, 340, 350, 360, 370, 380, 392, 394, 396. The system include more or less modules in in other embodiments.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Example terms for the modules 210, 220, 230, 240, 250, 260, 270, 280 include the following:
310 Driving-destinations input module
320 User-state input module
330 Environmental-context input module
340 Other's-profiles input module
350 User-activity input module
360 Contextual-mode selection module, or contextual agent
370 Contextual-modes database module
380 Contextual-mode generation module
392 Extra-dynamics vehicle output module
394 Connected-devices output module
396 Vehicle-dynamics output module

Each module can include code for communicating with a user-vehicle interface for receiving user indications of relevant characteristics. The indications are in various embodiments, express indications, or direct user input, from the user, such as:
a user activity—e.g., user selects a “reading newspaper” option on a touch-sensitive screen;
a user state—e.g., user tells the vehicle that “I'm getting sleeping”;
an environmental condition—e.g., tell the vehicle that “it's starting to snow”;
a destination—e.g., user indicates on a wearable, such as a smart watch, that the next destination is a specific restaurant; the watch can automatically or upon user request communicate the destination to the present vehicle system.

The input could be received by the corresponding input module of the group 302. For instance:
Driving destinations can be received by the driving-destinations input module 310;
User-state inputs can be received by the module user-state inputs 320;
Environmental-context inputs can be received by the environmental-context input module 330;
Other's-profiles inputs can be received by the other's-profiles input module 340;
User-activity inputs can be received by the user-activity input module 350.

User input could also expressly select any pre-established contextual mode, such as by selecting it from a list presented to the use5 by way of a vehicle screen, or by saying a name of the mode.

Each module can include one or more submodules (not shown in detail). Each input module can include a intake sub-module, for receiving contextual data relevant to its functions, a storage sub-module having rules and/or data to use in processing respective contextual data, and a processing sub-module for processing the respective contextual before outputting it to the modules of the deliberation group 304, for instance.

Supporting or sub-modules can include, for example, one or more driver-account modules and/or passenger-account modules for use in creating and maintaining user accounts, which can include preferences, settings, the like, and other. Any of these features can also be stored at the database module 370 and/or a remote database, such as of a remote server 50 (FIG. 1).

Sub-modules could also include, as other examples, a location, or geo-positioning, context module, a temporal-, scheduling-, planning-, or itinerary-context sub-module, such as one concerned with time of day or date, or a user schedule, itinerary, or other plan.

In some embodiments, the system can be configured to receive user preferences or condition (plans, activities, states, etc.) provided by the user explicitly by any of a variety of potential interfaces or modalities. The system can present a menu list of preferences or conditions for the user to choose from, for instance. Or the system, i.e., any module, can be configured to learn preferences off line, or online while driving, as described further below. In some embodiments, the system is configured to update preferences remotely, such as via a remote customer center or server 50 when the user is not in the car.

The modules, sub-modules, and their functions are described further below.

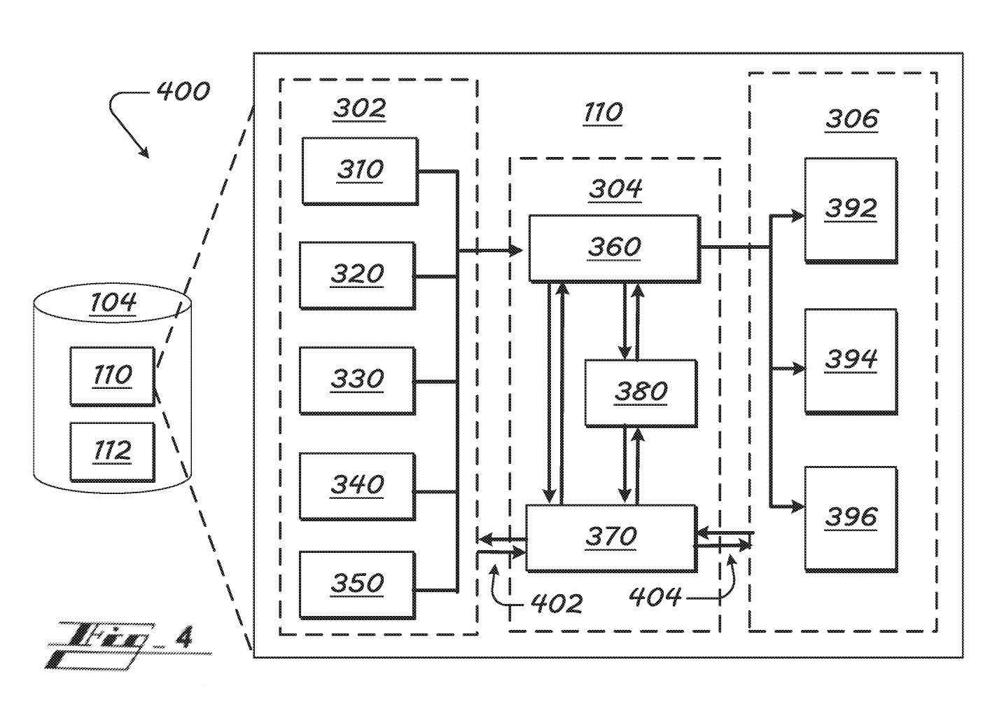

### V. Algorithms and Processes−FIG. 4

V.A. Introduction to the Algorithms

FIG. 4 shows an example algorithm, represented schematically by a process flow 400, according to embodiments of the present technology. Though a single process flow is shown for simplicity, any of the functions or operations can be performed by one or more devices or systems, in one or more or processes, routines, or sub-routines of one or more algorithms.

It should be understood that the steps, operations, or functions of the process 400 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated process 400 can be ended at any time.

In certain embodiments, some or all operations of the process 400 and/or substantially equivalent operations are performed by a computer processor, such as the hardware-based processing unit 106, executing computer-executable instructions stored on a computer-readable medium, such as one or both of the data storage device 104 of the system 20 described above.

By way of the modules of the input group 302, the system, using the processor 106, receives input from any of a variety of sources. Sources include but are not limited to sensors of the sensor sub-system 60, remote sources such as a remote server 50. As mentioned, the sensor sub-system can include any known vehicle sensor, and also user-vehicle interfaces, such as touch screen displays, buttons, knobs, speech to a microphone voice-to-text or voice-to-data sub-system, user interaction with a user-wearable device, visual input, such as gesture, the like, other, or any combination of different available modalities.

the like, or other can also be considered part of the sensor sub-system 60.

The sources for the input group 302 can also include vehicle data storage system, such as the database module 370. Such communication with the database module 370 is indicated by reference numeral 402 in FIG. 4.

The sources for the input group 302 can also include sources separate from and in communication with the vehicle 10, such as local or remote user devices, mobile devices, other vehicles, or local infrastructure (beacons, roadside transmitters, etc.) 50.

The contextual-mode selection module, or contextual agent 360 receives input data from the input group 302 and, particularly, from any one or more of the modules of the group 302.

V.B. Driving-Destinations Input Module 310

The driving-destinations input module 310 provides to the contextual-mode selection module or contextual agent 360 data indicating a present driving destination for the user.

Example destinations include but are not limited to work, home, and vacation.

The driving-destinations input module 310, and system generally, can be configured to determine a present destination for the vehicle in any of a variety of ways.

As one example, the vehicle can receive a selection or other indication of the destination from the user via a user-vehicle interface, such as a vehicle button or touch-sensitive display screen on which the system presents such options to the user. In contemplated embodiments, the system is configured to allow some such destinations (e.g., work, home, vacation) to be pre-set and/or to allow the user to initiate creation of a new destination to be stored in the system. After driving to a regular meeting held midday each Wednesday, for instance, the driver can select an option in the system, via the interface, to store the driving style just performed and other relevant indicia (e.g., radio volume, phone settings (e.g., phone policy), etc.) to a new destination setting, which is named, e.g., “Wednesday Lunch Meeting” or “Work2” with “Work” or “Work1” corresponding to a main work location.

In some embodiments, the system is configured to recommend to the user formation of a new destination, such as in response to determining that the vehicle has been driven to a new destination, that the vehicle has been driven to the new destination multiple times (a threshold of visits may be set to trigger the formation), and/or that the vehicle was driven and/or other relevant devices (e.g., phone, HVAC, radio) were used in a unique manner as compared to other pre-set driving-destination contextual modes. The system in a contemplated embodiment, establishes such additional destination, such as under similar circumstances (noticing that the vehicle has been driven to a new location multiple times, etc.), without requiring user approval, and with or without notifying the user.

As another example of how the driving-destinations input module 310, and system generally, can be configured to determine a present destination for the vehicle, the system can be configured to determine a present destination based on past user activity. If the user drives from Manhattan to the Catskill Mountains of New York every other Friday for years, and perhaps also driving at moderate or leisurely speeds, the system can learn (learning agent function) and assume that the driver will at this time on every other Friday be driving in to a vacation destination.

The vehicle system can equate the drive with a vacation contextual mode, for instance. The function can be performed using a dynamic user model learned on-line based on user activities with the vehicle over time and/or off-line, such as based on user input, such as user input provided by way of an application associated with the present system and configured to affect settings of the system.

In various embodiments, data informing a present selection of contextual mode can be learned by the system from conditions related to other trips or learned based on user input over time. Such learning can be stored at the system, or remote system or server 50 or user smart device 50, as a user model. The model can be used further by the system while the driver is in the car or is planning the trip remotely

The system can be configured to determine an actual or likely destination by prediction based on one more data points, such as user habit, user behavior, social media (texts, email, voicemail, social network data) related to the user or others (friends, family, colleagues). The system in some implementations can perform the prediction or estimation automatically, so that the user is not bothered by the system to ask about the destination unless the system cannot determine the likely destination.

As still another example of how the driving-destinations input module 310, and system generally, can be configured to determine a present destination for the vehicle, the system can be configured to determine a present destination based on a user itinerary, schedule, or calendar stored at or accessible by the vehicle 10.

In some embodiments, the destination can be based on a social relationship or condition. The vehicle system can determine where the user will driver based on movement data or social media data associated with the user and/or of one or more friends, family members, co-workers, etc.

As still another example of how the driving-destinations input module 310, and system generally, can be configured to determine a present destination for the vehicle, the system can be configured to determine a present destination based on a user itinerary, schedule, or calendar stored at or accessible by the vehicle 10. The external source can be a local or remote device distinct from the vehicle 10, such as from a user smartphone 50 or a remote server 50 maintaining the user itinerary, schedule, or calendar.

V.C. User-State Input Module 320

The driver-state input module 320 provides to the contextual-mode selection module 360 data indicating a present driver state, or state of one or more passengers, such as a chauffeured passenger or members of a family being driven by an autonomous vehicle. Or a group of commuters, or a group of riders that share a drive (ad hoc created group due to shared topics or affinity—e.g., shared or similar interest, age, gender, etc.).

Example user states include but are not limited to attentiveness level, quality, or capacity, drowsy or low-attentiveness, high-energy, morning (e.g., more subdued and business like), after-work (e.g., more relaxed, personal like), and moods, such as sad, energetic, low-key, or happy.

User states can also include any information about user perception or physiological or behavioral trait, such as a direction of user's eye gaze, and the various ways that such perceptions or behavioral or physiological trait can be interpreted, or semantics.

User states can also include user age, or medical conditions, which can be obtained from a user profile stored at the vehicle (e.g., database module 370) or obtained from an external source 50, for instance, or stored in the cloud, in a remote server 50, or in the user's mobile device or smart device 50, etc.

An example user state, includes vehicle passengers desiring or requiring certain conditions, such as elderly passengers being transported to a health care center. Or the state can correspond to the fact that passengers are children, such as a baby in a back seat, or students on a school bus, calling for a softer ride and/or select HVAC or infotainment settings, for instance.

The user state can also be determined by the system based on past experience with the user. The system can be configured to recognize past decisions and preferences of the user, such as if the user slowed down and lowered radio volume each time driving on a university campus, or turned up the HVAC fan and drove faster whenever driving on a country road. This can include many other systems of the car or of a user connected device that is activated in the car, for example: comfort, infotainment, navigation, lights, wipers, seats, sun roof, brakes and speed (ACC. gears, steering), media devices and systems on smart devices or mobile devices. In a contemplated embodiment, it includes ambience parameters like smell, interior/exterior lights, colors, sounds, the like, and other.

The user-state input module 320, and system generally, can be configured to determine the user state in any of a wide variety of ways. As an example, the system can be configured to determine the user state based on data from the sensor sub-system 60. A camera can monitor a user's face and/or eye posture and movement to determine whether they are attentive, for instance.

As another example input to the user-state input module 320, for determining user state to pass on to the deliberation group 304, the system can be configured to present optional user states to the user, such as via display screen or by way of a conversational mode using vehicle speakers and microphone. In a contemplated embodiment, the user can interact with the system to establish a new user state when no existing state is applicable.

The system can include a wizard, having one or more inquiries (questions, steps, or options), for interviewing or walking the user through the type of state they are in, so the vehicle can determine appropriate corresponding settings—e.g., settings for HVAC, cruise control, radio, smartphone, etc.

The user state can also be based on a user itinerary, calendar, or schedule stored at the vehicle—database module 370, for instance—or a device 50 distinct from the vehicle. The module 320 can be configured to determine, based on pre-established data, that the user tends to be in a lively, attentive mood after leaving his in-laws' house, for instance. The module 320 could, then, provide related data to the deliberation module 304 before or when leaving the in-laws', based on having determined, based on such available itinerary information, that the user is planning or expected to leave their house.

As another example of how the user-state input module 320 determines user state, the system can be configured to determine user state based on past or historic user behavior. For instance, the vehicle can determine that the user is in a before-work-type of mood based simply on the fact that the user is apparently driving to work in the morning as usual, such as based on location and time of week/day. The function can be referred to as learning, or a learning-agent function of the system. Again, such function can be performed using a dynamic user model learned on-line based on user activities with the vehicle over time and/or off-line, such as based on user input, such as user input provided by way of an application associated with the present system and configured to affect settings of the system.

V.D. Environmental-Context Input Module 330

The environmental-context input module 330 provides to the contextual-mode selection module 360 data indicating one or more relevant pieces of environmental contextual data for use in selecting or generating a contextual mode.

Example environmental context data include weather, traffic, car occupancy, road condition, type of road (e.g., highway vs. street), presence of nearby vehicles, and actions or dynamics of nearby vehicles, such as a car driving in a particular manner (e.g., overly aggressive) in an opposite lane, a hazard ahead such as a crossing pedestrians or other obstacles. Environmental context in various embodiments includes social environment, such as who is driving, who else is in the vehicle, and their profiles and preferences—e.g., type of music, type of ride, volume levels, temperature, etc.

The environmental-context input module 330, and system generally, can be configured to determine the environmental context(s) in any of a wide variety of ways. As an example, the system can be configured to determine the environmental context based on data from the sensor sub-system 60. Cameras and/or other vehicle sensors can be used to monitor dynamics of nearby vehicles, the road, or weather, for instance. Weather can also be obtained from a weather service, via the network 40 or short-range connection, such as from a user device 50. Road types, road conditions, and/or travel conditions can also be received from central services or navigation data from a traffic or navigation service, via the network 40 or short-range connection such as with a user mobile device.

As another example of how the environmental-context input module 330 determines environmental context, the system can be configured to determine environmental context based on past or historic activity. For instance, the vehicle can determine that when the vehicle was driven in a certain area, the road had certain conditions, such as a dirt surface consistently encountered on a particular road when a user takes the vehicle on vacation. The function can be referred to as learning, or a learning-agent function of the system. This function too can include use of a user-dynamic module, like those mentioned above.

V.E. Other's-Profiles Input Module 340

The other's-profile input module 340 provides information to the deliberation group 304 about one or more profiles associated with other users. The profile can indicate one or more contextual modes, indicating various settings (vehicle and/or non-vehicle—e.g., smartphone or wearable) and could include circumstances in which they are used, such as morning before work, vacation, on a particular stretch of road, during a particular time of year, or under certain weather conditions, for instance.

In various embodiments the other's-profile input module 340 is configured to provide profiles corresponding to one or more of any of: a family member of the user, a friend of the user, a user in a vehicle in a vicinity—e.g., within 5 miles, in the same city—and profiles used by others in the vicinity.

In a contemplated embodiment, the other's-profile input module 340 is configured to provide profiles corresponding to other pre-determined individuals, such as a celebrity or famous person, such as a popular singers, actor/actress, and famous athletes. A user may be interested in driving using settings of a famous person of their choice. Example settings include vehicle-dynamics settings—e.g., brakes, steering, chassis, powertrain (engine acceleration, transmission), wipers, external and/or internal lights—or generally, riding, handling, comfort, etc. Other vehicle settings include, for instance, HVAC, infotainment, seat position—e.g., adjusted so rear passengers can also see a movie screen in level five autonomous driving, etc., and personal device settings—smartphone ringer type, ringer volume, etc.

In various embodiments the other's-profile input module 340 is configured to generate a profile using past experiences of more than one other user, or obtain the profile created as such, such as from a vehicle database (e.g., database module 370) or a database of a remote device 50. The generation in some implementations involves using statistical knowledge or data regarding many users, collected via crowdsourcing, for instance. The profile created can meld characteristics of profiles of other users having one or more similarities to the present user, such as age, commute path to work/home, other route, personal preferences (e.g., music stations, vehicle settings), and present location.

In a contemplated embodiments, the system is configured to allow the user to perform a search, such as to search for a contextual mode corresponding to/balancing fastest driving/shortest commute time and maximum user comfort. The search can search the profiles of other users, and perhaps note their prior feedback, such as feedback indicting that a ride, through expedited, was comfortable. Or the user can indicate other desired characteristics of his experience, and the system identify the most applicable contextual mode, or creates one. The system can for these functions consult local resources (database module 370) and/or remote resources, such as a customer-service server or center 50.

Contextual modes that are associated with other people can be referred to as social modes, and profiles indicating them can be referred to as social profiles. In a contemplated embodiments, the social profiles or social modes can be obtained via a social media or social network configured to share contextual profiles or modes. The social platform is in a contemplated embodiment hosted by a customer surface center 50, such as the mentioned Onstar® center.

V.F. User-Activity Input Module 350

The user-activity input module 350 provides to the contextual-mode selection module 360 data indicating a present or planned activity of the driver or one or more passengers, such as a chauffeured passenger or members of a family being driven by an autonomous vehicle, or a social ride, such as an ad-hoc or previously created group.

Example user activities include but are not limited to the user reading, taking a nap, relaxing, or meditating, or planning or expected to do any of these things during fully-autonomous driving.

Other example user activities include the user being: on vacation, in a hurry, in a productive or busy condition, entertained (e.g., watching a movie during autonomous driving), interested in saving energy or fuel (eco condition), or in a leisure condition (e.g., vacation or weekend or after a big project is completed).

In various embodiments, the user activity can relate to what the user is transporting in the vehicle, such as food, medicine, fragile contents, or type of animals or people—e.g., children (also mentioned as a possible user-state factor). A vehicle can be made cooler when temperature-sensitive pharmaceuticals, for instance. A vehicle or peripherals/connected-devices can be made quieter (infotainment, phone ringer, HVAC, etc.) to calm pets, or sooth, or not bother a young child determined based on vehicle sensors to be napping.

The user-activity input module 350, and system generally, can be configured to determine the user activity in any of a wide variety of ways. As an example, the system can be configured to determine the user activity based on data from the sensor sub-system 60. A camera can monitor a user's face and/or eye posture and movement to determine whether they are drowsy or otherwise having lowered driving attention or capacity, which can indicate need for a sleepy- or sleep-related mode, initiating, for instance, a more- or fully autonomous driving state of the vehicle 10.

As another example input to the user-activity input module 350 for determining user activity to pass on to the deliberation group 304, the system can be configured to present optional user activities to the user, such as via display screen or by way of a conversational mode using vehicle speakers and microphone. In a contemplated embodiment, the user can interact with the system to establish a new user activity when no existing activity is applicable.

The system can be pre-arranged to include a resting mode, but not a reading, relaxing, or meditation mode, for instance, and further configured to let the user establish a reading, relaxing, or meditation modes for fully autonomous driving. The system may interact with the user to determine that a new relaxation/meditation mode can be like a sleep or resting mode, but with provision of a certain type and volume of music (from vehicle and/or user device playlist) and with a different HVAC setting then the sleep or resting mode.

The system can include a wizard, including one or more inquiries (e.g., steps or choices), for interviewing or walking the user through the type of activity or mode settings they are in, so the vehicle can determine appropriate corresponding settings—e.g., settings for HVAC, cruise control, radio, smartphone, etc.

The user activity can also be based on a user itinerary, calendar, or schedule stored at the vehicle (e.g., database module 370) or a device 50 distinct from the vehicle. The other's-profile input module 340 can be configured to know, for instance, that the user tends to nap in fully autonomous driving after dinner at his parents' house and heading home late. The module 350 could, then, provide related data to the deliberation module 304 before or when leaving the in-laws, based on having determined, based on such available itinerary information, that the user is planning or expected to leave his parents' house and head out on a long trip to the user's house.

In various implementations, the itinerary or user input indicates activity of a user or group of users in the vehicle, such as friends on the way to a party chatting heavily, in autonomous or semi-autonomous driving.

As another example of how the user-activity input module 350 determines user activity, the system can be configured to determine user activity based on past or historic user behavior. For instance, the vehicle can determine that the user may want to read after leaving a book store, based on vehicle location and past user behavior, including selecting a reading-related mode after leaving the bookstore. The function can be referred to as learning, or a learning-agent function of the system. The function can use a dynamic-user module like those mentioned above.

V.G. Contextual-Mode Selection Module 360

As mentioned, the contextual-mode selection module 360 receives input data from the input group 302 and, particularly, from any one or more of the modules of the group 302.

The contextual-mode selection module 360 is in various embodiments configured to consider input from more than one module of the input group 302 at a time in determining which contextual mode to apply via the output group 306.

The contextual mode determined can be implemented by one or more of the output modules 306, and one or more components (e.g., vehicle sub-systems, user wearables or other connected devices, etc.) associated with a control scope for the output modules.

The contextual-mode selection module 360 is configured to select a contextual mode best suited for the circumstances indicated by data received from the input group 302. The module 360 is configured to do this by an original designer or engineer, and in some implementations can be further configured to do so by system learning—learning-agent functions, for example—and/or user input—e.g., user input to reconfigure aspects of the system, such as the type of contextual mode selected in connection certain circumstances. The user input can be received via a user-vehicle interface for instance.

In various embodiments, the module 360 is configured to determine an applicable or best contextual mode based on input, such as relatively abstract input, that only suggests, or informs, the selection, not expressly indicating a contextual mode. And as mentioned further below, the module 360 and/or the generation mode 380 is/are configured to generate new contextual modes. In some implementations, the system is configured to translate relatively abstract, or non-express, input into best settings for the circumstances, or context, and, based on the settings determined, determine or create an applicable contextual mode.

Example components or functions that can be adjusted, or turned on or off, and associated with contextual modes include, but are not limited to:

Vehicle-Dynamic Settings
brakes, automatic cruise control, power steering, all-wheel drive (e.g., how wheels controlled regarding slip), chassis, powertrain, shock absorbers/dampers, energy-saving system, wipers, lights (external and/or internal), gear shifting, driving modes like sport/tour/normal, etc.

Non-Vehicle Dynamics Vehicle Settings
seat position, seat temperature, HVAC settings, radio or other infotainment settings, media output location or other media output characteristics (volume, etc.), navigation system, lights, wipers, audio, windows, sun roof, colors, smells, etc.

Non-Vehicle/Connected-Device Settings
connected device music playlist, phone policies—such as which emails, texts, or phone calls come through or trigger a user notification or a certain type of notification, etc.

As an example vehicle settings, shock absorbers can be set to a normal, sporty, or leisure setting, or interim settings created, for instance, based on the context such as user activity or environmental conditions. The powertrain can be set to react normally to depression of the accelerator pedal, for instance, or to react in a slightly delayed or slightly aggressive manner based on the context, such as a present route or weather conditions identified based on weather-service data or one or more vehicle sensors. Power steering assistance can be normal or weaker or stronger than normal based on the circumstances. These are just a few examples regarding vehicle settings.

As an example of non-vehicle-dynamics vehicle settings, an HVAC system can have be set to various temperature, fan, humidity, and output ports for instance, such as to activate a defrost setting under certain weather conditions automatically, without user manual input at the time.

As another example non-vehicle-dynamics vehicle settings, the vehicle infotainment system can be adjusted according to context, such as by adjusting a radio station and volume to match a user activity (e.g., relaxing or meditation during autonomous driving) or user state (e.g., when the user is apparently in a spirited mood).

As another example non-vehicle-dynamics vehicle settings, vehicle communication system can be adjusted such as to allow or disallow incoming communications, or control a type of notification for incoming communications, based on the circumstances. As an example, only work and family calls accepted by the vehicle during morning commute, along with infotainment system being set to industry or general news.

As an example of non-vehicle settings, a user device such as a smartphone can be adjusted according to its various settings to perform in any of various ways based on context. A ringer volume could be adjusted or the ringer turned off when the user is napping during autonomous driving, for instance. Or the phone can be set to a policy allowing certain texts, calls, or emails through, or to control notification of same, based on context.

Regarding implementations at the contextual-mode selection module 360, as only a few non-limiting examples of selecting contextual mode or settings, the contextual-mode selection module 360 can be configured to associated the following input, or context, with the following corresponding contextual mode or contextual-mode settings:

| Context (Input) | Contextual Mode/Settings |
|---|---|
| Driving to work | Contextual to-work mode: Set radio |
| (Based on data from the | station to news, phone policy for all |
| driving-destinations input | calls get in, driving mode sport, |
| module 310, for instance) | HVAC cool |
| Driving home from work | Contextual home-after-work mode: |
| (Based on data from the | Set music to my playlist on mobile, |
| driving-destinations input | phone policy only family, driving |
| module 310, for instance) | mode comfort, HVAC mild |
| Driving to or on vacation | Contextual vacation mode: Set music |
| (Based on data from the | to kids, phone policy selected; driving |
| driving-destinations input | mode: tour; HVAC adjusted to group |
| module 310, for instance) | in car and back seat passengers; |
| | media set to back seat entertainment; |
| | navigation system (NAV) set to |
| | scenic drive and energy saving |
| | condition or state |
| User in a hurry | Contextual hurry mode: Set NAV to |
| (Based on data from the user- | fastest (energy is less a priority), only |
| activity input module 350, for | urgent calls; HVAC: cold; driving |
| instance) | model: sport, combined with |
| | supporting NAV |
| User in a busy or productive | Contextual busy or productive mode: |
| state | Focused communication-related |
| (Based on data from the User- | functions, whether vehicle and/or |
| activity input modules 350, for | connected device function, mainly on |
| instance) | work tasks efficiency, such as by |
| | filtering out non-work related |
| | communications, and lower sounds |
| | to increase productivity, such as |
| | lower HVAC and radio sounds. |
| User in an entertained state | Contextual entertained mode: |
| (Based on data from the user- | Focused vehicle dynamics, non- |
| state input module 350, for | dynamics, and/or non-vehicle |
| instance) | settings on comfort (softer ride, |
| | cooler temperature, etc.), and |
| | optimize any vehicle dynamics, non- |
| | dynamics, and/or non-vehicle |
| | settings on providing the |
| | entertainment - e.g., setting the |
| | vehicle to semi or fully autonomous |
| | driving mode, setting a visual display |
| | to high-definition, and a |
| | communication link to high-speed. |
| User activity is a movie activity | Movie contextual mode: |
| (Based on data from the User- | Infotainment system set to present |
| activity input module 350, for | movie, to all passengers sensed, if |
| instance) | not already set; sound adjusted so all |
| | can hear movie audio well; seats |
| | adjusted so that all can see the |
| | movie well. |
| User activity is a | Relaxation/Meditation contextual |
| relaxing/meditation activity | mode: Affects, for instance, sounds, |
| (Based on data from the User- | smell or aromas that the vehicle can |
| activity input module 350, for | be configured to provide (e.g., |
| instance) | lavender, mint); Can affect other |
| | systems in the vehicle to give the |
| | user a relaxing/meditative |
| | atmosphere, such as the infotainment |
| | system to provide soft music from a |
| | user playlist or satellite radio station; |
| | and a navigation system to initiate |
| | provision of a soft “gong” or other |
| | comforting sound to alert the user |
| | when the destination is being |
| | approached so they can peacefully |
| | exit the relaxation/meditation |
| | process. |

V.H. Contextual-Modes Database Module 370

In various embodiments, the contextual-mode selection module 360, a contextual-mode generation module 380 and/or any of the modules of the input or output groups 302, 304, consult a contextual-mode database module 370. Example uses of the database are referenced above.

The database module 370 stores pre-established contextual modes that the contextual-mode selection module 360 selects from, based on the circumstances data from the input group 302.

The contextual-mode selection module 360 and/or an input module 302 in various embodiments consult the database module 370 to obtain user-specific data, such as user age, other user characteristics.

In embodiments or implementations in which output settings are not present in an instruction from the selection module 360 to the output group 306, or stored in the output group 306, the output group 306 can be configured to retrieve or otherwise obtain from the database module 370 such settings, corresponding to an instructed contextual mode from the selection module 360. Interaction between the output group 305 and the database module 370 is indicated by reference numeral 404 in FIG. 4.

These are only example uses of the database module 370, which can perform generally any data- or instruction-related function facilitating the contextual-based operations described herein.

V.I. Contextual-Mode Generation Module 380

As referenced, in various embodiments the system is configured to create a contextual mode, the system not being previously pre-set with the new mode.

In a contemplated embodiment, the system is programmed with a default mode. The mode can be set to average values, for example—a normal driving mode, auto mode HVAC, etc.

In various embodiments, the system includes a learning-agent functionality including software (e.g., artificial-intelligence code) allowing the system to determine a better contextual mode based on past and/or present circumstances, such as user behavior and any combination of user behavior and relevant context.

As a simple example, if each time the system, in response to a certain circumstance, selects a first mode, “2×”, the user adjusts half of the applicable settings to settings matching a second mode, “3×”, then the vehicle can for such circumstance create a new third mode, “2.5×” including the other half of the initial settings from 2×, which were not changed by the user, and the settings that the user changed to.

V.J. Output Group 306 (Modules 392, 394, 396)

As provided, the output group 306 comprises modules configured to initiate execution of the settings corresponding to the mode selected or generated at the deliberation group 304.

The various modules include the extra-dynamics, or non-dynamics, vehicle output module 392, the connected-devices output module 394, and the vehicle-dynamics output module 396,

As provided, example outputs include but are not limited to the following:

Vehicle-dynamic settings via the 3d output module 396:
brakes, automatic cruise control, power steering, all-wheel drive, chassis, powertrain, shock absorbers/dampers, energy-saving system, wipers, lights (external and/or internal);

Non-vehicle/Connected-device settings via the 2d output module 394:
connected device music playlist, phone policies—such as which emails, texts, or phone calls come through or trigger a user notification or a certain type of notification; and

Non-vehicle dynamics vehicle settings via the 1st output module 392:
seat position, seat temperature, HVAC settings, radio or other infotainment settings, media output location or other media output characteristics (volume, etc.), navigation system.

The process 400 can end or any one or more operations of the process 400 can be performed again.

VI. Select Advantages

Many of the benefits and advantages of the present technology are described above. The present section restates some of those and references some others. The benefits described are not exhaustive of the benefits of the present technology.

The system in various embodiments determines, by selecting or generating, an applicable contextual mode associated with pre-established settings. Automatic implementation by the system of the numerous settings associated with a contextual mode determined facilities vehicle use.

The automatic implementation is also efficient from the users perspective as the user does not have to adjust each of the settings manually for each context, or be distracted from driving or other activities (e.g., during autonomous driving) by having to do so.

By the contextual modes selected, and associated settings, user enjoyment and comfort with vehicle user is increased. Ease of vehicle use is increased by allowing implementation of custom modes automatically based on the circumstances.

VII. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

References herein indicating direction are not made in limiting senses. For example, references to upper, lower, top, bottom, or lateral, are not provided to limit the manner in which the technology of the present disclosure can be implemented. While an upper surface may be referenced, for example, the referenced surface need not be vertically upward, in a design, manufacture, or operating reference frame, or above any other particular component, and can be aside of some or all components in design, manufacture and/or operation instead, depending on the orientation used in the particular application.

Directional references are provided herein mostly for ease of description and for simplified description of the example drawings, and the thermal-management systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

In various embodiments, the system allows a user to set his own driving mode explicitly, such as from a given list of modes corresponding to predetermined parameters settings, such as for the vehicle (dynamic-related or non-dynamic (e.g., HVAC, infotainment), and/or non-vehicle systems.

In various embodiments, the system allows system or user customization to the user, establishing a new contextual mode. After driving in a certain manner, for instance, the system can propose or the user can initiate establishment of a new mode matching the manner. The system or user can then name the new contextual mode for future reference.

In various embodiments, the system allows system or user generate a new mode socially, such as by choosing a mode from any of: a group of friends, local users, a group of crowd-sourced users, or a given celebrity (e.g., a mode corresponding to a manner that a rock star is known to drive under similar circumstances, or generally).

In various embodiments, the system allows system or user generate a new mode specifically adapted to a fully autonomous driving experience that the user indicates or the vehicle detects, such as if the user is or is planning to be gaming, sleeping, watching a movie, working, meditating, talking/chatting, reading, or otherwise having their attention largely distracted from the autonomous driving. For instance, in some cases, the system is configured so that a person only needs to state the mode of driving and this will be interpreted in what actual settings need to be set in all systems and sub systems in the vehicle.

In various embodiments, the system integrates a driver's state and/or other user-, vehicle-, or driving-related context, to decide automatically on a more comprehensive driving modes affecting factors such as user comfort, privacy, navigation (routing, etc.), infotainment presentation, riding, engine or powertrain settings, or other.

Variations, modifications, and combinations may be made to the above-described embodiments without departing from the scope of the claims. All such variations, modifications, and combinations are included herein by the scope of this disclosure and the following claims.

What is claimed:

1. A system, for controlling a vehicle function based on determined context, comprising:
a hardware-based processing unit; and
a non-transitory computer-readable storage device comprising:
an input group that, when executed by the hardware-based processing unit, obtains contextual input data for use in determining a contextual mode, wherein the contextual input is based on at least one of:
(i) an environmental context;
(ii) a user state;
(iii) a user driving destination;
(iv) a profile of the user; and
(v) a profile of another user;
a deliberation group that, when executed by the hardware-based processing unit, determines, based on the contextual input data, a contextual mode for use in controlling the vehicle function; and
an output group that, when executed by the hardware-based processing unit, initiates implementation, at a vehicle of transportation, of the contextual mode determined to control the vehicle function.

2. The system of claim 1, wherein the user state is based on vehicle sensor data indicating a quality of the user.

3. The system of claim 1, wherein the user state indicates a mood or activity of the user.

4. The system of claim 1, wherein the deliberation group is configured to determine the contextual mode based on the input contextual data and historic user data.

5. The system of claim 1, wherein the deliberation group, in determining the contextual mode, generates a new contextual mode based on the input context data.

6. The system of claim 5, wherein the deliberation group includes a learning agent that, when executed by the hardware-based processing unit, analyzes, user behavior, or user behavior and the context input data, and yields a learning output for use in generating the new contextual mode.

7. The system of claim 1, wherein the vehicle function is a non-driving function.

8. The system of claim 7, wherein the vehicle and/or non-vehicle function includes an infotainment sub-system function.

9. The system of claim 7, wherein the vehicle and/or non-vehicle function includes a heating, ventilating, air-conditioning function of the vehicle.

10. The system of claim 1, wherein the contextual mode determined is configured to promote a relaxing atmosphere for the user in a vehicle.

11. A system, for controlling a non-driving function of a vehicle based on determined context, comprising:
a hardware-based processing unit; and
a non-transitory computer-readable storage device comprising:
an input group that, when executed by the hardware-based processing unit, obtains contextual input for use in determining a contextual mode, wherein the contextual input is based on at least one of:
(i) an environmental context;
(ii) a user state;
(iii) a user activity;
(iv) a user driving destination;
(v) a profile of the user; and
(vi) a profile of another user;
a deliberation group that, when executed by the hardware-based processing unit, determines, based on the contextual input, a contextual mode for use in controlling a non-driving vehicle function; and
an output group that, when executed by the hardware-based processing unit, initiates implementation, at the vehicle, of the contextual mode determined to control the non-driving vehicle function.

12. The system of claim 11, wherein the user activity includes an item to be kept cool or cold, and the output group initiates execution of the contextual mode determined to control the heating, ventilating, air-conditioning function to keep the item cool or cold.

13. The system of claim 11, wherein the user state is based on vehicle sensor data indicating a quality of the user.

14. The system of claim 11, wherein the user state indicates a mood or activity of the user.

15. The system of claim 11, wherein the deliberation group is configured to determine the contextual mode based on the input contextual data and historic user data.

16. The system of claim 11, wherein the deliberation group, in determining the contextual mode, generates a new contextual mode based on the input context data.

17. The system of claim 16, wherein the deliberation group includes a learning agent that, when executed by the hardware-based processing unit, analyzes, user behavior, or user behavior and the context input data, and yields a learning output for use in generating the new contextual mode.

18. The system of claim 1, wherein the function includes a mobile-device function.

19. A system, for controlling a vehicle function based on determined context, comprising:
a hardware-based processing unit; and
a non-transitory computer-readable storage device comprising:
an input group that, when executed by the hardware-based processing unit, obtains contextual input for use in determining a contextual mode, the contextual input including data from an other-user profile or environmental data;
a deliberation group that, when executed by the hardware-based processing unit, determines, based on the contextual input, a contextual mode for use in controlling a vehicle function; and
an output group that, when executed by the hardware-based processing unit, initiates implementation, at a vehicle of transportation, of the contextual mode determined to control the vehicle function.

20. The system of claim 19, wherein the deliberation group:
in determining the contextual mode, generates a new contextual mode based on the input context data; and
includes a learning agent that, when executed by the hardware-based processing unit, analyzes, user behavior, or user behavior and the context input data, and yields a learning output for use in generating the new contextual mode.
